(19) United States
(12) Patent Application Publication
(10) Pub. No.: US 2010/0026086 A1
(43) Pub. Date: Feb. 4, 2010

(54) TWO-WIRE ADDRESSING SCHEME

(76) Inventors: Jerry Siegel, Los Angeles, CA (US); Mitchell Budnlak, Highland Park, IL (US); Kerry S. Berland, Chicago, IL (US); Paul Berland, Elgin, IL (US); Rick Stellmacher, Cupertino, CA (US); Phillippe Habib, Mountain View, CA (US)

Correspondence Address: LAW OFFICES OF EUGENE M. CUMMINGS, P.C., ONE NORTH WACKER DRIVE, SUITE 4130, CHICAGO, IL, 60606, US

(21) Appl. No.: 12/185,642

(22) Filed: Aug. 4, 2008

(51) Int. Cl. H04B 3/54

(52) U.S. Cl. 307/2

(57) ABSTRACT

A two-wire communications system is disclosed. The disclosed communications system uses a distributed power line and a distributed common line to transmit messages. A power transistor is operated to transmit either a logical high or a logical low using the two signal lines.

### FIELD OF THE INVENTION

The present invention relates generally to systems, apparatus, and methods for addressing and/or selecting electronic devices within a device, and more particularly to systems, apparatus, and methods for assigning an address to an electronic device, and even more particularly to systems, apparatus, and methods for assigning an address to an electronic device using a two-wire addressing scheme.

### DESCRIPTION OF THE PRIOR ART

Addressing electronic devices is a common problem within the field of electronics design. For example, it is common to buffer input/output lines leading from one printed circuit board (“PCB”) to an external connector or another PCB, rather than route the data bus or I/O pins of a processor directly to a connector. Often input/output buffers are addressed as part of the memory space of the processor by generating a select line based on a particular value being output by the processor's address bus. For example, assuming a 16-bit processor, when the value 0xFFFE is output, an or gate coupled to the address bus of the processor may generate a high value, activating the select input of a particular buffer, and allowing that buffer to be read or written.

Two-wire buses are also well-known in the art. For example, U.S. Pat. No. 4,689,740 (“the '740 patent”), issued on Aug. 25, 1987, discloses a two-wire bus system comprising a clock wire and a data wire, and is hereby incorporated by reference in its entirety. The '740 patent discloses a synchronous data bus using a clock line and a data line; a configuration that is used frequently in various electronic devices.

While the prior art provides means to address electronic devices, there still exists a need to address electronic devices in certain circumstances. For instance, certain electronic devices, such as toy race tracks or configurations of multiple lights, could be made very simply and inexpensively using a microprocessor and the electronic devices but for the need to individually address the different electronic devices. One example of a device where addressing makes a substantial difference in simplicity and cost is an electronic Yahrzeit. A Yahrzeit is a panel used in a Jewish synagogue to commemorate the death of a member of the congregation; an individual lamp is lit in a particular location. Using traditional addressing schemes, constructing a typical Yahrzeit panel including hundreds of individually addressable lamps involves complex wiring and switching elements.

### OBJECTS OF THE INVENTION

Accordingly, it is an object of the invention to provide an improved two-wire addressing scheme.

Another object of the invention is to provide an improved method for setting the address of an electronic device using a two-wire addressing scheme.

Other advantages of the disclosed invention will be clear to a person of ordinary skill in the art. It should be understood, however, that a system, method, or apparatus could practice the disclosed invention while not achieving all of the enumerated advantages, and that the protected invention is defined by the claims.

### SUMMARY OF THE INVENTION

The disclosed invention achieves its objectives by providing an improved two-wire communications system for transmitting a message from one electronic device to another. Instead of using separate signal lines, the disclosed communications system uses a distributed power line and a distributed common line to transmit messages. In one embodiment of the disclosed invention, the two-wire communications system comprises a direct current power line and a common line with the channel of a power transistor coupled across them. A bus controller controls the power transistor to transmit messages using the power line and common line.

In an alternative embodiment of the disclosed invention, a second power transistor is used as well. In this embodiment, the second power transistor couples the direct current power source powering the direct current power line to the direct current power line. Accordingly, in the default state, the direct current power line will output a logical high. When a logical low must be output, the bus controller uses the second power transistor to decouple the direct current power source from the direct current power line. Leakage across the transistor will maintain the direct current power line at the logical high level until the first power transistor is used to couple the direct current power line to the common line, thereby bringing the direct current power line to a potential near ground.

In another alternative embodiment of the disclosed invention, a network of addressable lamps is controlled. In this embodiment, the controlled electronic device comprises a light-emitting diode and a regular diode. The anode of the regular diode is coupled to the direct current power line, while the cathode is coupled to the light emitting diode. A capacitor is also coupled to the cathode of the regular diode and to the light emitting diode as well. The capacitor is used to power the light emitting diode when a logical low is transmitted by the direct current power line. A processor monitors the direct current power line and in response to messages received via the direct current power line, activates or deactivates the light emitting diode.

### BRIEF DESCRIPTION OF THE DRAWINGS

Although the characteristic features of this invention will be particularly pointed out in the claims, the invention itself, and the manner in which it may be made and used, may be better understood by referring to the following description taken in connection with the accompanying drawings forming a part hereof, wherein like reference numerals refer to like parts throughout the several views and in which:

FIG. 1 is a schematic view of an addressable lamp constructed in accordance with an embodiment of the disclosed invention;

FIG. 2 is a timing diagram illustrating the data format used to address and communicate with the addressable lamp of FIG. 1;

FIG. 3A-C is a schematic view of a control board adapted to communicate with the addressable lamp of FIG. 1 and constructed in accordance with an embodiment of the disclosed invention; and

FIG. 4 is an illustration of a Yahrzeit constructed in accordance with an embodiment of the invention.

### DETAILED DESCRIPTION OF THE ILLUSTRATED EMBODIMENT

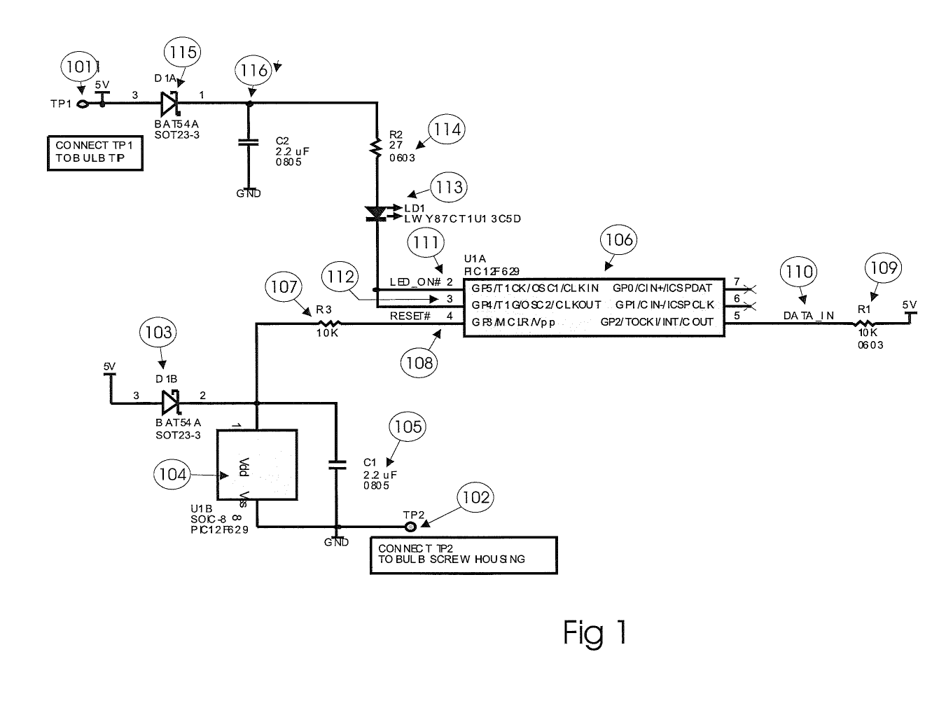

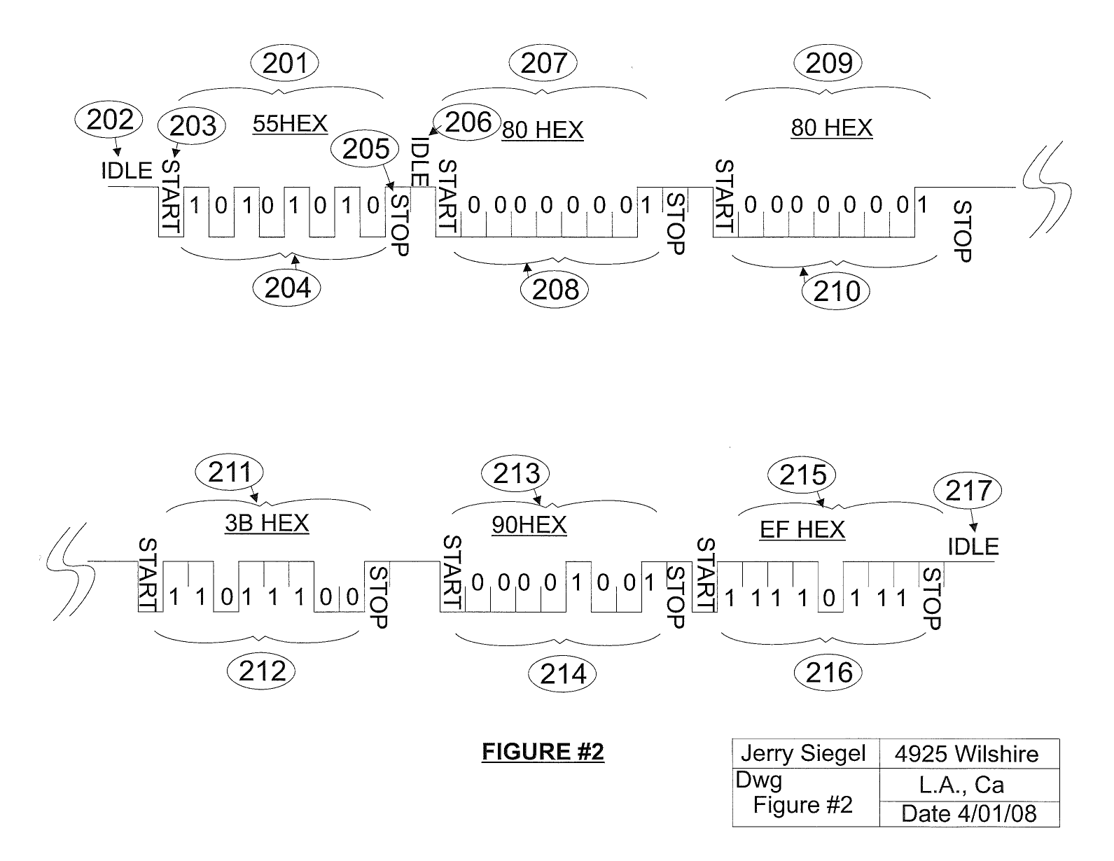

Turning to the Figures, and to FIG. 1 in particular, a schematic of a lamp incorporating a two-wire bus is depicted. The illustrated two-wire bus utilizes a five-volt (5V) power signal, which doubles as an asynchronous data line, and a common or ground signal. In the particular embodiment of the disclosed two-wire bus depicted in FIG. 1, a 5V signal is applied via a wire from the tip of a lamp socket to first connection point 101. The ground or common signal is connected via a wire to a lamp socket screw housing at a second connection point 102. The 5V signal is passed through a Schottky diode 103 to the power section 104 of microcontroller 106. This signal is referred to herein as the “power signal.” Similarly, the ground signal is connected to the power section 104 of microcontroller 106 as well.

Capacitor 105, which could be approximately 2.2 micro-Farads (“uF”), provides a power storage function. Normally capacitor 105 is charged to approximately 4.6 volts, which is 5 volts less the forward voltage drop of Schottky diode 103. When the voltage at the 5V bus goes to 0 volts during data transmission or reception as described later in this application, Schottky diode 103 becomes reverse biased, and capacitor 103 supplies power to the power section 104 of microcontroller 106.

Microcontroller 106 is used to communicate over the disclosed two-wire bus, and also to determine whether or not to light the lamp it is coupled to. There are a variety of microcontrollers available that could serve this function; for example, the PIC12F629 available from Microchip could be used. For purposes of illustration only, the remainder of this application refers to specific elements of a PIC12F629. The power signal is applied to the reset pin of microcontroller 106 through a resistor 107. A logical high signal applied to the reset pin causes the microcontroller 106 to initialize its internal state and begin executing code.

Microcontroller 106 monitors the state of the 5V signal for data communications from other devices. The 5V signal is routed through resistor 109 to an interrupt pin of microcontroller 106. Note that no other signal conditioning is used so as to enable microcontroller 106 to accurately detect data bits sent using the 5V signal.

While most microcontrollers have the capability of running from precise quartz crystal or ceramic resonators, some microcontrollers also incorporate an internal timing source. For example, the PIC12F629 incorporates an internal RC oscillator with a frequency tolerance of approximately ±5%. However, to properly receive data over the 5V signal, greater precision may be required based on the transmission speed of the data. As described below, in these circumstances, a synchronizing header may be used to overcome an unacceptably imprecise internal oscillator.

When microcontroller 106 receives a command specifying that the bulb controlled by the microcontroller 106 should turn on, it sets its two pins 111 and 112 to output a logical low, i.e., zero volts, thereby activating light-emitting diode (“LED”) 113. Two pins are used in parallel to provide greater current sinking capacity. LED 113 is normally powered by the 5V signal through Schottky diode 115. However, during data reception the 5V signal will be driven low, and LED 113 will then be powered for short intervals by capacitor 116, which may be approximately 2.2 uF as illustrated.

When an addressable lamp is constructed, the microcontroller 106 is loaded with firmware. The firmware loaded into the microcontroller 106 will assign the lamp address 0x0000. As discussed later, this address may be changed by an installer with a proper tool

FIG. 2 illustrates one possible data format that could be used to communicate with the lamp of FIG. 1 in accordance with the disclosed invention. The illustrated data format is asynchronous stat/stop non-return to zero (“NRZ”), and is compatible with RS-232, so as to allow personal computer data ports, various universal asynchronous receiver/transmitter (“UART”) devices, and various serial communication interface (“SCI”) devices.

FIG. 2 illustrates a string of six bytes transmitted over the disclosed two-wire bus. The first byte, denoted by identifier 201, is a synchronization byte that consists of alternating ones and zeros, i.e., 0x55 in hexadecimal format. The microcontroller 106 may use the bit timing in the synchronization byte 201 to calibrate itself to the incoming data stream, which, as illustrated, is sent at 2400 bits-per-second.

When the bus is inactive the line is in the idle state 202, and the 5V signal powers all devices coupled to the bus. A start bit 203 signals the beginning of a data byte. The start bit 203 is followed by a payload 204 consisting of eight data bits, which are followed by a stop bit 205. For the data bits, the least significant bit is sent first, and the most significant bit is sent last. This format is commonly referred to as 8N1, i.e., eight data bits, no parity, and one stop bit. A start bit is always logic level low, i.e., nearly zero volts (0V). A stop bit is always logic level high, i.e., nearly five volts (5V). After a byte is transmitted, the bus line momentarily transitions to the IDLE level 206. A start bit signals the transmission of the next byte, which in this case is the first of two address bytes. The most significant bit of each packet aside from the synchronization byte or command byte is always set to logic level high in the disclosed message protocol. As the most significant bit of each packet is always set to logic level high, it is disregarded, and the address encoded within payloads 208 and 210 is actually address 0x0000, and not address 0x8080.

Following the address bytes one or more command bytes may be sent. The number of bytes within a command may vary, as the first byte or first several bytes may indicate that more bytes are forthcoming. In this case, byte 211 is the only command byte sent, and as shown, the payload 212 is 0x3B hex. This particular command causes an addressed lamp to blink; as address 0x0000 was sent out, all lamps will blink as all lamps respond to address 0x0000. Note that this messaging protocol could be used to send any type of data message.

Following the command or command bytes a pair of checksum bytes are sent. The first checksum byte 213 is the one byte sum of all preceding bytes, meaning that any overflow over 0xFF is not carried into the result. As with all other bytes, the most significant bit is always set. In this case, the value of the previous bytes is 0x55, 0x80, 0x80, and 0x3B. Their one byte sum is 0x90; as the most significant bit is already set, it is not adjusted. Accordingly, the payload 214 of byte 213 is set to 0x90.

The second checksum byte 215 is the one byte additive inverse of the first checksum byte; i.e., its value is set 0xFF less the value of the first checksum byte. In this case, the payload 216 of the second checksum byte 215 is set to 0xFF minus 0x90, or 0x6F. However, as with all other bytes, the most significant byte is set to logic high, so 0x6F becomes 0xEF.

After a string of bytes is sent, the 5V line remains idle 217 until it is time to send another string of bytes.

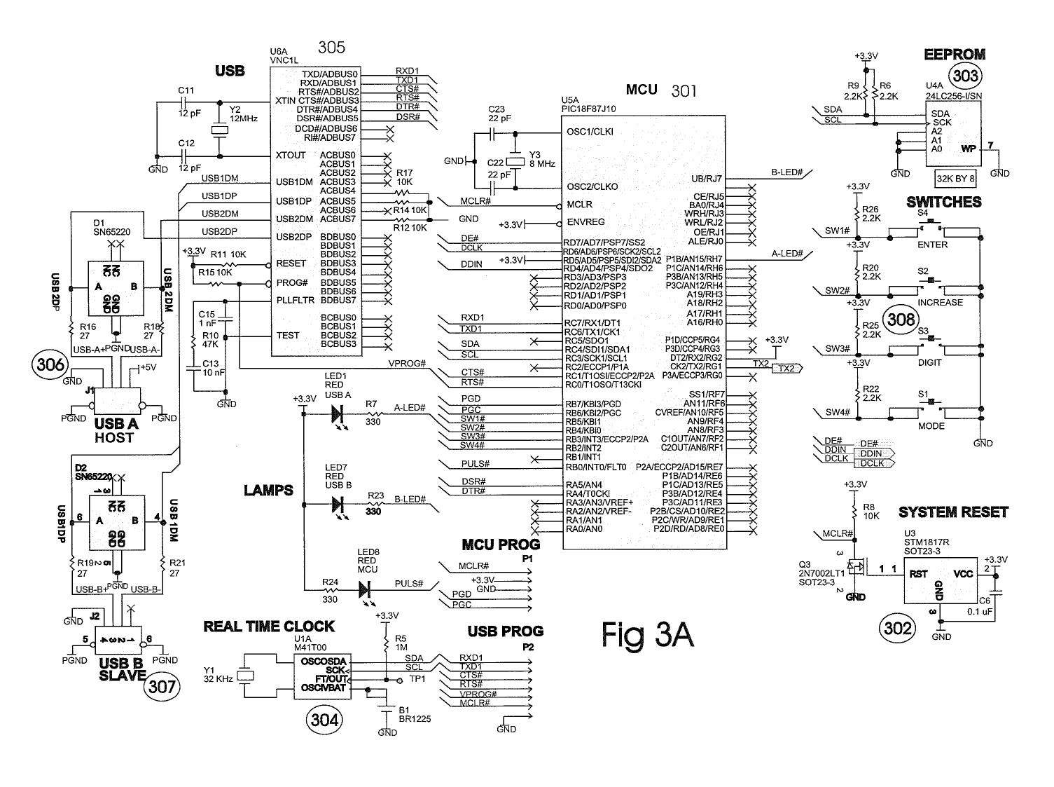

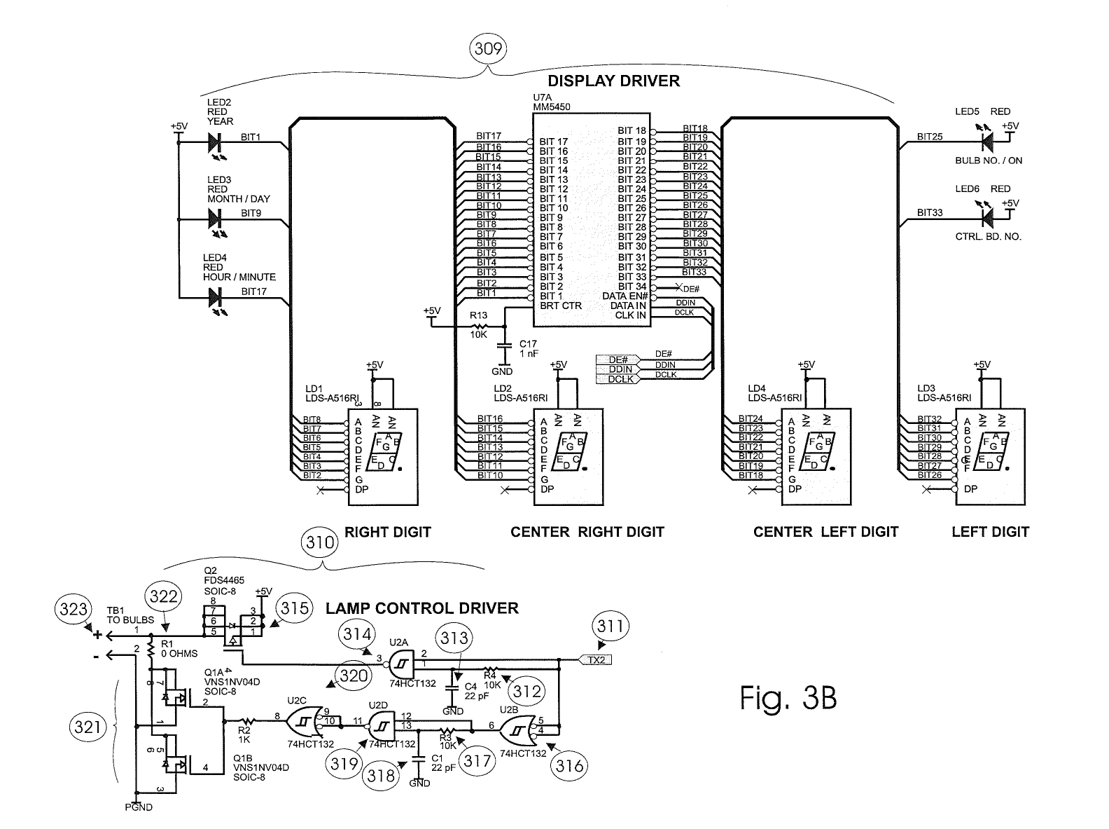

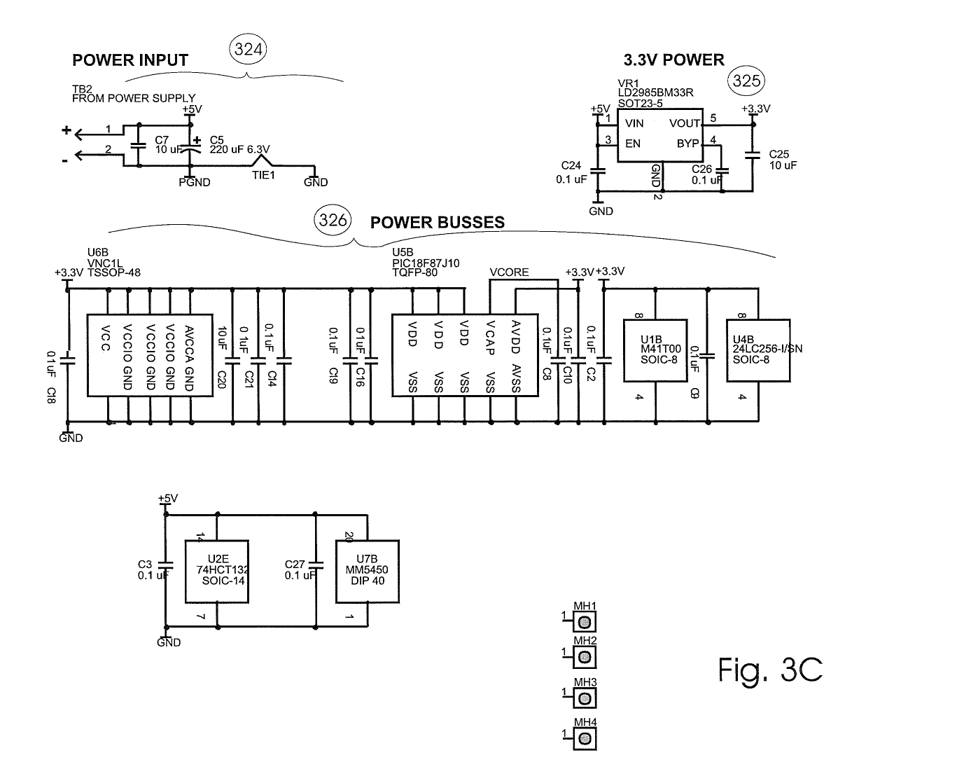

Turning to FIG. 3A, a controller board for illuminating lamps according to a preset schedule is depicted. Microcontroller 301 executes a control program that provides overall control of the lamp illumination schedule. There are numerous available microcontrollers that could function for this purpose. As illustrated, a Microchip PIC18F87J10 is used; this device advantageously incorporates FLASH memory allowing it to be reprogrammed in-circuit using appropriate tools. System reset circuit 302 insures that microcontroller 301 is properly initialized. Electrically erasable programmable read-only memory 303 stores system parameters that may need to be changed from time to time.

Real-time clock 304 maintains the date and time, and utilizes a battery to provide back-up power. Microcontroller 301 uses real-time clock 304 to maintain the proper illumination schedule for lamps under its control. Universal Serial Bus (“USB”) Controller 305 provides two USB interfaces. USB host port connector 306 provides a port into which a USB drive may be inserted containing a data base that links individual bulb numbers with the days and times on which those bulbs should be illuminated. The USB drive may be programmed using a utility operating on a personal computer. USB slave port 307 can be used to connect to a personal computer, allowing for an alternate mechanism to download a bulb illumination schedule into the system.

Turning to FIG. 3B, switches 308 can be used by users along with display 309 to check and adjust the day and time, and to manually send commands to bulbs. Display 309 provides a four-digit seven-segment display that can be used by an operator in conjunction with switches 308 to verify and change the current state of the system.

Bus control driver 310 contains interface logic for driving the previously described two-wire bus. Transmit signal 311 may be driven by a UART within microcontroller 301. Transmit signal 311 is normally high, i.e., near five volts, when the communications link is idle. When idle, resistor 312 charges capacitor 313 to near five volts as well. NAND gate 314 outputs a logic low, i.e., near zero volts, when its two inputs are held high in the bus idle state. The output of NAND gate 314 is connected to the gate input of P-channel power MOSTFET 315, and when NAND gate 314 outputs a logic level low, MOSFET 315 is switched on, which couples the five volt signal to the bus at bus terminal 323.

Transmit signal 311 is also coupled to inverter 316. When the bus is idle, the input to inverter 316 is logic level high, and, accordingly, the output of inverter 316 is logic level low. Both of the inputs of NAND gate 319 are also low, thereby causing the output of NAND gate 319 to be high. The output of NAND gate 319 is coupled to the inputs of a second inverter 320, which accordingly outputs logic level low when the bus in the idle state. The output of inverter 320 is coupled to the gates of a second MOSFET 321, which, as depicted here, is a dual unit with its outputs connected in parallel. As the gates of MOSFET 321 are driven low in the bus's idle state, MOSFET 321 is switched off, and accordingly, does not affect the voltage seen at bus terminal 323.

When a logic zero bit is sent on the two-wire bus, transmit signal 311 is driven low for the duration of the zero bit. Once transmit signal 311 is driven low, the output of NAND gate 314 will change to output logic level high. Power MOSFET 315 is switched off, thereby decoupling the five volt power signal from the data bus.

Further, when transmit signal 311 goes low the output of inverter 316 is driven to logic level high. The output of inverter 316 is coupled directly to one input of NAND gate 319 and indirectly to the other input of NAND gate 319 through a resistor 317 and a capacitor 318, thereby introducing a time delay before both inputs of NAND gate 319 are driven high. This delay is introduced to prevent MOSFET 321 from turning on before MOSFET 315 has turned off. After this delay, the output of NAND gate 319 is driven low, and thereby the output of second inverter 320 is driven high, thereby activating MOSFET 321. When MOSFET 321 is activated a low-resistance short is effectively placed across both terminals 321,323 of the two-wire bus, thereby driving the data signal to a logic level low.

When transmit signal 311 again is driven to logic level high, the output of inverter 316 is again driven low, thereby immediately driving the output of NAND gate 319 high. The output of inverter 320 is then driven low, thereby deactivating MOSFET 321 and allowing the bus to return to the five volt level. Further, one input of NAND gate 314 is driven high, but the other input of NAND gate 314 is not driven high until after a slight delay due to resistor 312 and capacitor 313. This delay is necessary to prevent MOSFET 315 from turning on before MOSFET 321 has turned off. After the delay, the output of NAND gate 314 is driven low, activating transistor 315 and coupling the five volt signal to bus terminal 323.

Power section 324 consists of a connector for receiving regulated 5V power from an external supply. In addition, voltage regulator 325 generates 3.3V power if it should be required. Power bus section 326 illustrates the various power connections on the control board.

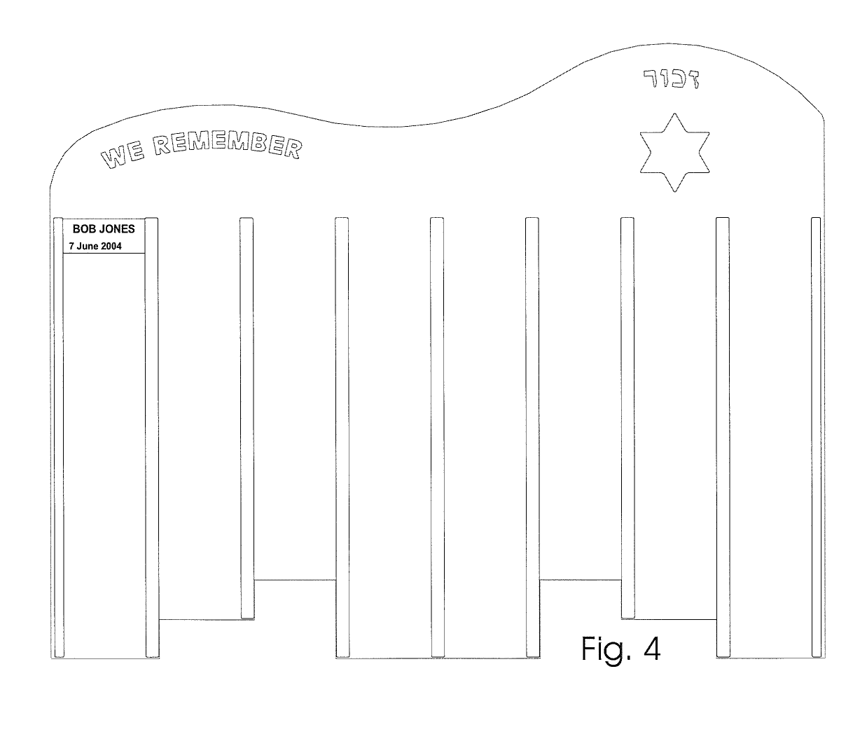

While the majority of this application has been directed to a novel two-wire communications bus, the remainder will deal with the use of this bus within a lighting control system, and more specifically, within a Yahrzeit. After a circuit board as illustrated in FIG. 1 is constructed, the lamp board is inserted into a lamp base, and the assembly is tested. For example, in the Yahrzeit pictured in FIG. 4, a fixture will be situated under the visible front of the Yahrzeit, and hundreds of lamp boards will be inserted into lamp bases. A control board will interface with all of the different lamp boards using the disclosed two-wire bus. Prior to installing the lamp board, a new address will be programmed into the lamp board so that it is individually addressable. As explained earlier, the address may be set using a personal computer with an RS232 port and an appropriate cable, or with a specially constructed tool if desired. The new address will be stored in the nonvolatile memory within the microcontroller on the lamp board indefinitely. Further, if an installer should become confused as to the address of a particular lamp board, he may send the lamp board an “IDENTIFY” command, which will cause the lamp board to blink out its address in decimal format, one digit at a time. For example, if the lamp boards address is seventy seven, it may blink seven times at a rate of 2 Hz, followed by a 2 second pause, and then blink seven times more, again at a rate of 2 Hz.

While this document has covered specific examples of how the disclosed invention could be used within specific applications, such as lighting control, persons skilled in the art will appreciate that the disclosed invention could be used in many applications using direct current powered devices and a digital communications bus. For example, the disclosed communications system could used to implement a model train control system, whereby an image of a model train set was developed using a computer system, and a USB connection was then used to control all track switching and other control functions. In addition, the disclosed communications system could be used to control numerous functions within automobiles presently using direct current powered elements and digital control systems.

The foregoing description of the invention has been presented for purposes of illustration and description, and is not intended to be exhaustive or to limit the invention to the precise form disclosed. The description was selected to best explain the principles of the invention and practical application of these principles to enable others skilled in the art to best utilize the invention in various embodiments and various modifications as are suited to the particular use contemplated. It is intended that the scope of the invention not be limited by the specification, but be defined by the claims set forth below.

What is claimed is:

1. A two-wire communications system for transmitting a message to an electronic device and for supplying power to said electronic device, said two-wire communications system comprising:
i) a direct current power line;
ii) a common line;
iii) a power transistor coupled to said direct current power line and to said common line;
iv) a bus controller coupled to said power transistor, said bus controller further adapted to control said power transistor to transmit a message to said electronic device.

2. The two-wire communications system of claim 1 further comprising:
i) a direct current power source; and
ii) a second power transistor coupled to said direct current power line and to said direct current power source,
wherein said bus controller is adapted to transmit a message to said electronic device by controlling said power transistor and said second power transistor.

3. The two-wire communications system of claim 1 wherein said electronic device is an addressable lamp comprising:
i) a light-emitting diode;
ii) a diode comprised of an anode and a cathode, the anode being coupled to said direct current power line;
iii) a capacitor coupled to the cathode of said diode and to said light emitting diode, said capacitor storing energy from said direct current power line and supplying energy to said light-emitting diode; and
iv) a processor coupled to said light-emitting diode, said direct current power line and to said common line, said processor receiving said message and activating said light-emitting diode based on said message.

4. The two-wire communications system of claim 3 incorporated into a Yahrzeit.
